(19) United States
(12) Patent Application Publication
(10) Pub. No.: US 2024/0332873 A1
(43) Pub. Date: Oct. 3, 2024

(54) COAXIAL CONNECTOR AND ASSEMBLY OF THE SAME

(71) Applicants: FUNDING PRECISION COMPONENTS (SHENZHEN) CO., LTD., Shenzhen (CN); FOXCONN INTERCONNECT TECHNOLOGY LIMITED, Grand Cayman (KY)

(72) Inventors: DE-JIN CHEN, Shenzhen (CN); SHIH-WEI HSIAO, New Taipei (TW)

(21) Appl. No.: 18/618,138

(22) Filed: Mar. 27, 2024

(30) Foreign Application Priority Data
Mar. 30, 2023 (CN) 202320737775.1

(51) Int. Cl. H01R 24/50; H01R 13/502; H01R 103/00

(52) U.S. Cl. CPC H01R 24/50; H01R 13/502; H01R 2103/00

(57) ABSTRACT

A coaxial connector includes: a floating terminal module having a first insulating housing, a first inner conductor received and retained in the first insulating housing, and a first outer conductor; and a fixed terminal module comprising a second insulating housing, a second inner conductor, and a second outer conductor, wherein the first inner conductor has a mating portion extending upwardly and a first connecting portion extending downwardly, the first outer conductor has a third connecting portion extending downwardly, the second inner conductor has a second connecting portion and a soldering tail, the second outer conductor has a fourth connecting portion and a soldering portion, the first connecting portion elastically abuts the second connecting portion downward, the third connecting portion is floatingly connected to the fourth connecting portion, and the floating terminal module uses the first connecting portion as a fulcrum to deflect radially relative to the fixed terminal module.

### BACKGROUND OF THE INVENTION

### Field of the Invention

The present invention relates to a coaxial connector and an assembly of the same, achieving a floating pattern for signal transmittion of a car camera.

### Description of Related Arts

China Patent No. CN218005411U discloses a floating electrical connector which includes a floating upper shell and a fixed lower, an insulator retained with conductive terminals therein. The lower shell is fixedly mounted on a printed circuit board and the upper shell is engaged with the lower shell and can shift compared with the lower shell. The insulating housing is retained in the upper shell, the conductive terminal includes a soldering tail to be mounted on the printed circuit board at the bottom end thereof. The soldering tail has an upper end which is flexibly to absorb the swinging deformation of the conductive terminal. Since the soldering tails are soldered to the printed circuit board, the swing range of the conductive terminals is limited, which cannot meet the offset mating requirements of coaxial connector at various angles.

An improved coaxial connector is desired.

### SUMMARY OF THE INVENTION

An object of the present invention is to provide a coaxial connector and a coaxial connector assembly with better floating connection performance.

To achieve the above-mentioned object, a coaxial connector comprises: a floating terminal module comprising a first insulating housing, a first inner conductor received and retained in the first insulating housing, and a first outer conductor surrounding an outside of the first insulating housing, the first inner conductor having a mating portion extending upwardly and a first connecting portion extending downwardly, the first outer conductor having a third connecting portion extending downwardly; and a fixed terminal module comprising a second insulating housing, a second inner conductor fixed on the second insulating housing, and a second outer conductor surrounding an outside of the second insulating housing, the second inner conductor having a second connecting portion and a soldering tail, the second outer conductor having a fourth connecting portion and a soldering portion opposite the fourth connecting portion, wherein the first connecting portion elastically abuts the second connecting portion downward, the second outer conductor is assembled on a coaxial outside of the first outer conductor, the third connecting portion is floatingly connected to the fourth connecting portion, the floating terminal module uses the first connecting portion as a fulcrum to deflect radially relative to the fixed terminal module.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of a coaxial connector assembly in a mated statue of an embodiment of the present invention;

FIG. 2 is a perspective view of the coaxial connector assembly of FIG. 1, showing a coaxial connector and a mating connector are separated from each other;

FIG. 3 is another perspective view of the coaxial connector assembly of FIG. 2;

FIG. 4 is an exploded perspective view of the coaxial connector of FIG. 3;

FIG. 5 is a further exploded perspective view of the coaxial connector of FIG. 4;

FIG. 6 is another exploded perspective view of the coaxial connector of FIG. 5;

FIG. 7 is a cross-sectional view of the coaxial connector taken along line A-A in FIG. 3;

FIG. 8 is a cross-sectional view of the coaxial connector taken along line B-B in FIG. 3;

FIG. 9 is an exploded perspective view of the mating connector of FIG. 2;

FIG. 10 is a cross-sectional view of the coaxial connector assembly taken along line C-C in FIG. 3;

FIG. 11 is a cross-sectional view of the coaxial connector assembly taken along line C-C in FIG. 3, showing the coaxial connector and the mating connector of the present invention are normally mated; and

FIG. 12 is a cross-sectional view of the coaxial connector assembly taken along line C-C in FIG. 3, showing the coaxial connector and the mating connector of the present invention are offset and mated.

### DETAILED DESCRIPTION OF THE PREFERRED EMBODIMENT

Reference will now be made in detail to the preferred embodiments of the present invention.

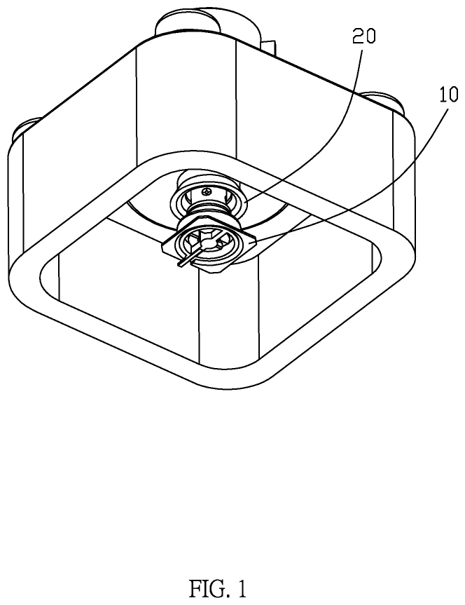

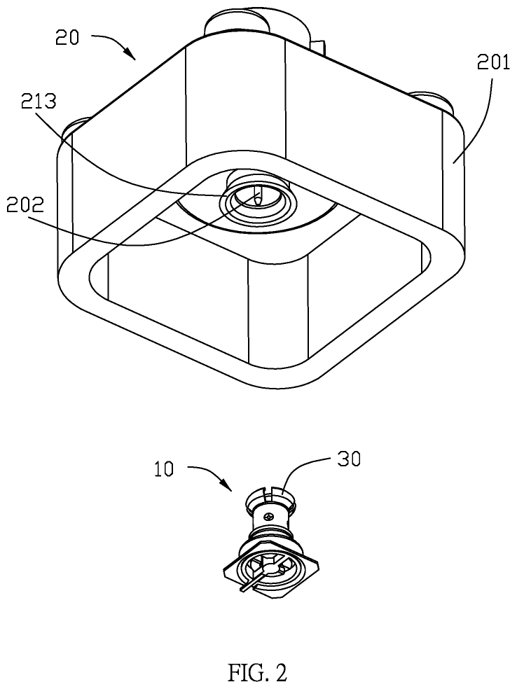

Referring to FIGS. 1-3 showing a coaxial connector assembly, the coaxial connector assembly includes a coaxial connector 10 mounted to a circuit board (not shown) and a mating connector 20 adapted for mating to the coaxial connector 10 and installed on an electronic equipment (not shown). The coaxial connector 10 and the mating connector 20 are both coaxial radio frequency connectors, such as Fakra. In this embodiment, the coaxial connector 10 and the mating connector 20 are used to transmit signals from car camera. The coaxial connector 10 and the mating connector 20 can float slightly relative to each other for avoiding vehicle vibration.

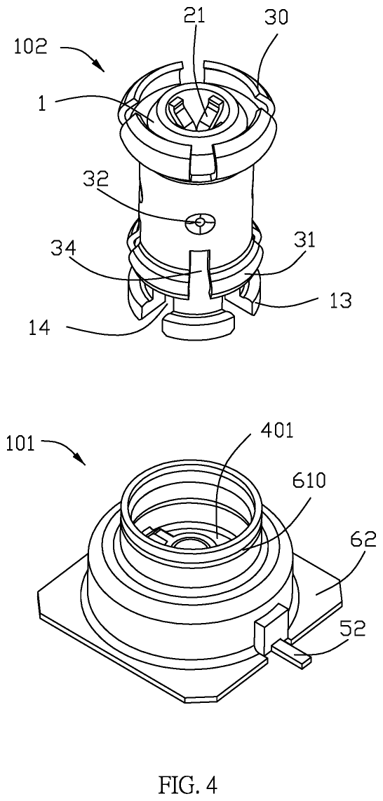

Referring to FIG. 4, the coaxial connector 10 comprises a fixed terminal module 101 and a floating terminal module 102. The floating terminal module 102 comprises a first insulating housing 1, a first inner conductor 2 received and retained in the first insulating housing 1, and a first outer conductor 3 surrounding an outside of the first insulating housing 1. The fixed terminal module 101 comprises a second insulating housing 4, a second inner conductor 5 fixed on the second insulating housing 4, and a second outer conductor 6 surrounding an outside of the second insulating housing 4. The first inner conductor 2 has a mating portion 21 extending upwardly and a first connecting portion 22 extending downwardly. The second inner conductor 5 has a second connecting portion 51 and a soldering tail 52 to be mounted on the circuit board. The first outer conductor 3 has a third connecting portion 31 extending downwardly and a mating part 30 extending upwardly. The second outer conductor 6 has a fourth connecting portion 61 and a soldering portion 62 opposite the fourth connecting portion 61. The first connecting portion 22 elastically abuts the second connecting portion 51 downward. The second outer conductor 6 is assembled on the coaxial outside of the first outer conductor 3. The third connecting portion 31 is floating connected to the fourth connecting portion 61. The floating terminal module 102 uses the first connecting portion 22 as a fulcrum to deflect radially relative to the fixed terminal module 101, thereby providing the condition of offset mating for the coaxial connector 10 and the mating connector 20.

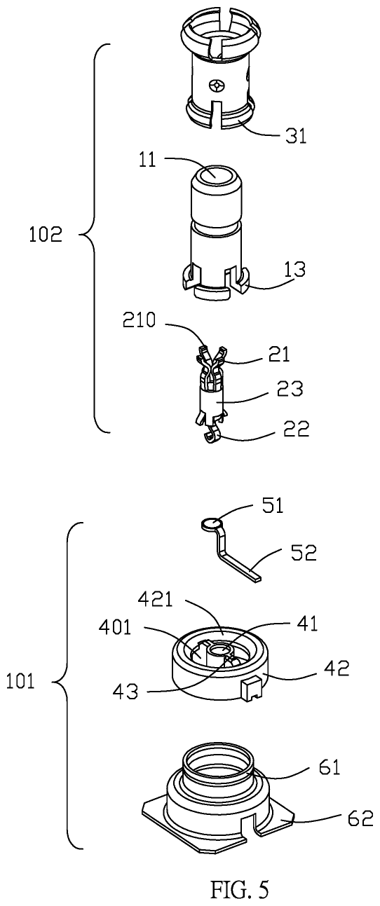

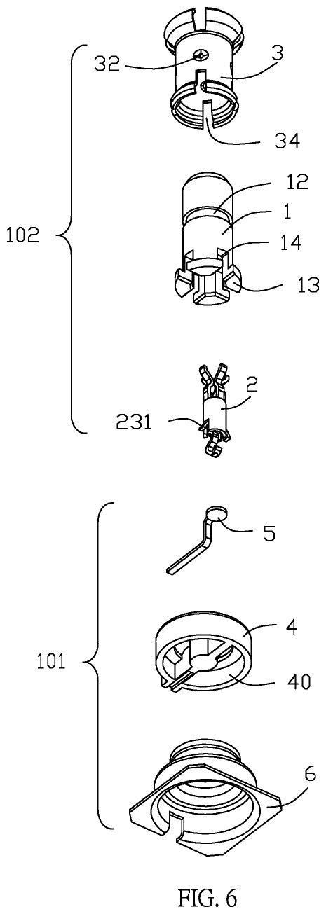

Referring to FIGS. 5-7, the first inner conductor 2 comprises a hollow cylindrical portion 23, a plurality of mating portions 21 upwardly extending from the cylindrical portion 23. The plurality of mating portions 21 surround and form a mating port 210. The first connecting portion 22 is arranged in an S shape and has a first bending portion 221 extending inwards from the cylindrical portion 23 and bending downwardly, and a second bending portion 222 extending outwardly from the first bending portion 221 and bending downwardly. The second connecting portion 51 is plate-shaped. The second bending portion 222 elastically contacts the second connecting portion 51 and deflects radially relative to the second connecting portion 51. Since the first bending portion 221 and the second bending portion 222 are elastic in an upper and lower direction, the first connecting portion 22 can drive the floating terminal module 102 to float in the upper and lower direction relative to the fixed terminal module 101 by elastic bending, which is beneficial to maintaining the stability of the floating terminal module 102 after offset mating and ensuring stable contact between the first outer conductor 3 and the second outer conductor 6. In this embodiment, when the radial offset distance of the fixed terminal module 101 relative to the mating connector 20 is less than or equal to 0.3 mm, the floating terminal module 102 can be mated to the mating connector 20 by radial deflection to transmit 6-9 Gbps high-frequency signals for meeting the needs of 8 million-4K pixel high-definition cameras.

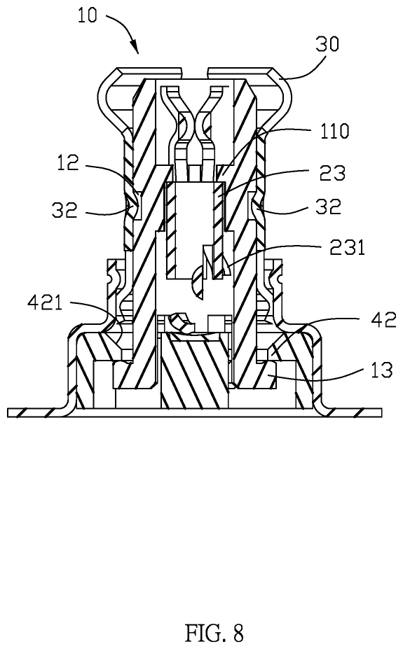

The following is a brief introduction to the assembly of the floating terminal module 102. The first inner conductor 2 can be fixed to the first insulating housing 1. Combining with FIGS. 5-8, in this embodiment, the first insulating housing 1 has a mating cavity 11 penetrating in the upper and lower direction and a stopping clasp 110 extending to the mating cavity 11. The first inner conductor 2 is assembled into the mating cavity 11 from bottom to top. The stopping clasp 110 is clamped on an upper edge of the cylindrical portion 23. A lower edge of the cylindrical portion 23 has a stopper 231 interference fit to an inner wall of the first insulating housing 1. Therefore, the first inner conductor 2 has a good holding effect in both the upper and lower direction and the radial direction. Referring to FIG. 8, in this embodiment, an outer wall of the first insulating housing 1 has a neck 12 concaved inwardly, the first outer conductor 3 has corresponding protrusions 32, the protrusions 32 are held in the neck 12.

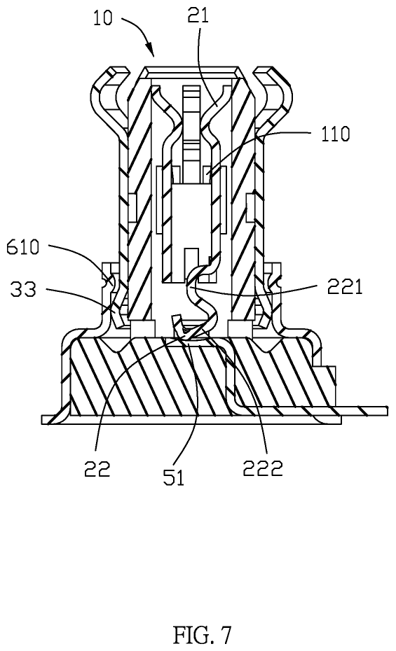

The following is a brief introduction to the assembly of the fixed terminal module 101. Combining with FIGS. 4-5, the second insulating housing 4 has a central island portion 41, an outer ring portion 42 surrounding the central island portion 41, a cavity 10 located between the central island portion 41 and the outer ring portion 42, and a bridge portion 43 connecting the central island portion 41 and the outer ring portion 42. As shown in FIG. 7, in this embodiment, the second insulating housing 4 and the second inner conductor 5 are held together by injection molding. The second connecting portion 51 is fixed on the central island portion 41. The soldering tail 52 extends downward from the second connecting portion 51 along the central island portion 41 and then extends outward along the bridge portion 43 out of the outer ring portion 42. The second outer conductor 6 is sleeved outside the second insulating housing 4 from top to bottom.

The following is a brief introduction to the matching between the floating terminal module 102 and the fixed terminal module 101. Referring to FIGS. 4-5, the cavity 40 has an opening 401 penetrating upwardly. The lower end of the first insulating housing 1 is inserted into the cavity 40 from the opening 401 and has a plurality of flanges 13 protruding radially outward. The flanges 13 are held by the outer ring portion 43 to limit the amplitude of radial deflection of the floating terminal module 102, which can avoid damage to the coaxial connector 10 caused by excessive deflection of the floating terminal module 102, and is benefit to improving the service life of the coaxial connector 10. Combining with FIG. 8, a top of the outer ring portion 42 comprises a guide portion 421 inclined inward and downward. The lower end of the first insulating housing 1 has a plurality of slots 14. The lower end of the first insulating housing 1 can be contracted inwardly and assembled into the cavity 40 along the guide portion 421, the bridge portion 43 is located in the slots 14. The third connection portion 31 has a convex ring 33 protruding outwards. The fourth connecting portion 61 has a concave ring 610 recessed inward. The concave ring 610 clasps the convex ring 33 above for limiting the floating of the third connecting portion 31 and preventing the third connecting portion 31 from falling off the second outer conductor 6. As shown in FIG. 4, the lower end of the first outer conductor 3 has a plurality of second slots 43, the lower end of the first outer conductor 3 can be contracted inwardly and assembled into the second outer conductor 6.

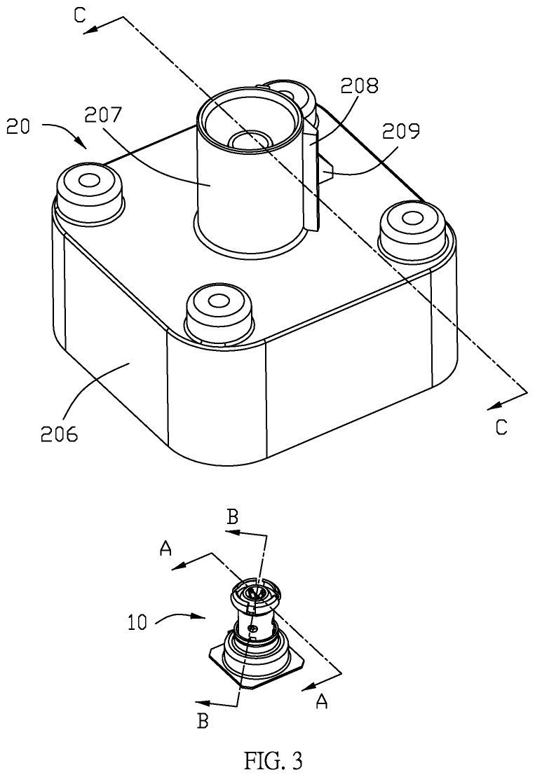

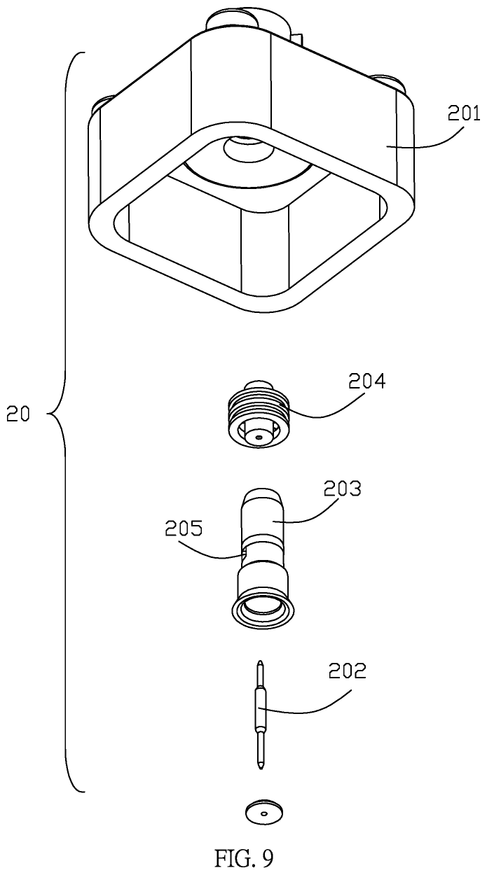

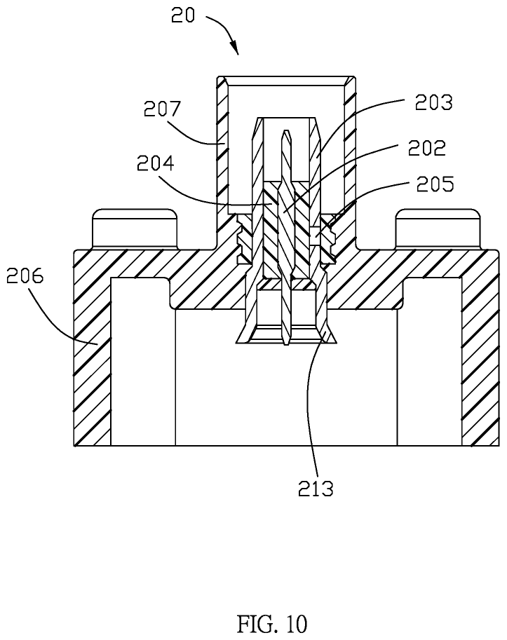

Referring to FIGS. 1-3 and FIGS. 9-10, the mating connector 20 is installed on the electronic equipment, which includes a case 201, a center terminal 202, a shielding shell 203 surrounding the center terminal 202, and a third insulating housing 204 located between the center terminal 202 and the shielding shell 203. In this embodiment, the third insulating housing 204 is injected from a injection molding port 205 on the shielding shell 203, thereby integrating the central terminal 202, the shielding shell 203 and the case 201 into a whole. A lower end of the shielding shell 203 has a mouth portion 213 for receiving the coaxial connector 10. In this embodiment, a glue dispensing process is further performed below the third insulating housing 204 to enhance the sealing performance of the mating connector 20. Preferably, with reference to FIG. 3, the case 201 comprises a main body 206 and a cylindrical mating part 207 extending upward from the main body 206. The mating part 207 has a number of protruding portions 208 and latching portions 209, which is helpful for guiding and fixing the external connector (not shown). In this embodiment, the central terminal 202 is in the shape of a needle and can be electrically connected to the mating portions 21. The mouth portion 213 of the shielding case is generally arranged in a trumpet shape and connecting to the mating part 30 of the first outer conductor 3.

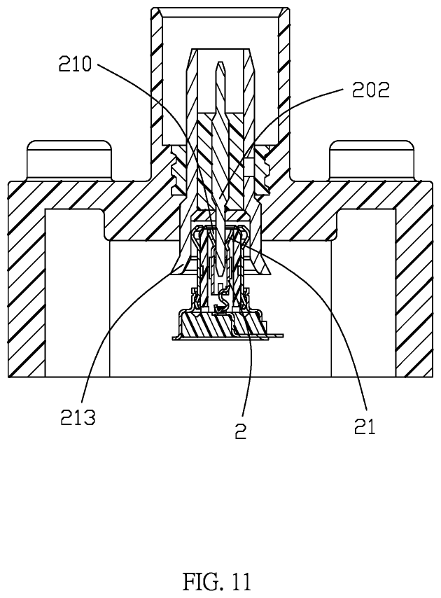

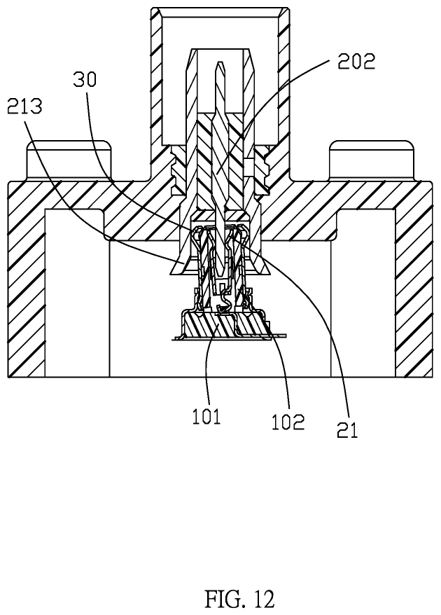

FIG. 11 and FIG. 12 are mating views of the coaxial connector 10 and the mating connector 20 in the normal mating position and the mating position offset by 0.3 mm, respectively. When the coaxial connector 10 and the mating connector 20 are mating with each other, the floating terminal module 102 can swing radially to adjust the mating angle. When the central terminal 202 is inserted into the mating port 210 surrounded by the mating portion 21, the floating terminal module 102 is affected by the insertion force and is displaced along the mouth 213 in the radial direction. Whether the coaxial connector 10 is in a normal mating position or in an offset mating position, the center terminal 202 can be connected to the first inner conductor 2.

Although the present invention has been described with reference to particular embodiments, it is not to be construed as being limited thereto. Various alterations and modifications can be made to the embodiments without in any way departing from the scope or spirit of the present invention as defined in the appended claims.

1. A coaxial connector comprising:
a floating terminal module comprising a first insulating housing, a first inner conductor received and retained in the first insulating housing, and a first outer conductor surrounding an outside of the first insulating housing, the first inner conductor having a mating portion extending upwardly and a first connecting portion extending downwardly, the first outer conductor having a third connecting portion extending downwardly; and
a fixed terminal module comprising a second insulating housing, a second inner conductor fixed on the second insulating housing, and a second outer conductor surrounding an outside of the second insulating housing, the second inner conductor having a second connecting portion and a soldering tail, the second outer conductor having a fourth connecting portion and a soldering portion opposite the fourth connecting portion;
wherein the first connecting portion elastically abuts the second connecting portion downward, the second outer conductor is assembled on a coaxial outside of the first outer conductor, the third connecting portion is floatingly connected to the fourth connecting portion, the floating terminal module uses the first connecting portion as a fulcrum to deflect radially relative to the fixed terminal module.

2. The coaxial connector as claimed in claim 1, wherein the first inner conductor comprises a hollow cylindrical portion and a plurality of mating portions upwardly extending from the cylindrical portion, the first connecting portion is arranged in an S shape and has a first bending portion extending inwards from the cylindrical portion and bending downwardly and a second bending portion extending outwardly from the first bending portion and bending downwardly, the second connecting portion is plate-shaped, and the second bending portion elastically contacts the second connecting portion and deflects radially relative to the second connecting portion.

3. The coaxial connector as claimed in claim 1, configured to be coaxially plugged into a mating connector, wherein when the radial offset distance of the fixed terminal module relative to the mating connector is less than or equal to 0.3 mm, the floating terminal module is mateable to the mating connector by radial deflection.

4. The coaxial connector as claimed in claim 2, wherein the first connecting portion is able to drive the floating terminal module to float in an upper and lower direction relative to the fixed terminal module by elastic bending.

5. The coaxial connector as claimed in claim 2, wherein the first insulating housing has a mating cavity penetrating in an upper and lower direction and a stopping clasp extending to the mating cavity, the stopping clasp is clamped on an upper edge of the cylindrical portion, and a lower edge of the cylindrical portion has a stopper interference fit to an inner wall of the first insulating housing.

6. The coaxial connector as claimed in claim 2, wherein the second insulating housing has a central island portion, an outer ring portion surrounding the central island portion, and a cavity located between the central island portion and the outer ring portion, the cavity has an opening penetrating upwardly, the lower end of the first insulating housing is inserted into the cavity from the opening and has a plurality of flanges protruding radially outward, and the flanges are held by the outer ring portion to limit the amplitude of radial deflection of the floating terminal module.

7. The coaxial connector as claimed in claim 6, wherein the second insulating housing comprises a bridge portion connecting the central island portion and the outer ring portion, the second connecting portion is fixed on the central island portion, and the soldering tail extends downward from the second connecting portion along the central island portion and then extends outward along the bridge portion out of the outer ring portion.

8. The coaxial connector as claimed in claim 2, wherein the third connection portion has a convex ring protruding outwards, the fourth connecting portion has a concave ring recessed inward, and the concave ring clasps the convex ring above for limiting the floating of the third connecting portion and preventing the third connecting portion from falling off the second outer conductor.

9. The coaxial connector as claimed in claim 2, wherein an outer wall of the first insulating housing has a neck concaved inwardly, and the first outer conductor has corresponding protrusions held in the neck.

10. The coaxial connector as claimed in claim 7, wherein a top of the outer ring portion comprises a guide portion inclined inward and downward, the lower end of the first insulating housing has a plurality of slots, the lower end of the first insulating housing is able to be contracted inwardly and assembled into the cavity along the guide portion, and the bridge portion is located in the slots.

11. A coaxial connector assembly comprising:
a coaxial connector comprising:
a floating terminal module comprising a first insulating housing, a first inner conductor received in the first insulating housing, and a first outer conductor surrounding outside of the first insulating housing, the first inner conductor having a mating portion extending upwardly and a first connecting portion extending downwardly; and
a fixed terminal module comprising a second insulating housing, a second inner conductor fixed on the second insulating housing, and a second outer conductor surrounding outside of the second insulating housing; and
a mating connector comprising a case, a center terminal, and a shielding shell surrounding the center terminal;
wherein the first connecting portion elastically abuts the second inner conductor downward, the second outer conductor is assembled on the coaxial outside of the first outer conductor, a lower end of the first outer conductor is floatingly connected to an upper end of the second outer conductor, the mating portion is electrically connected to the central terminal, the first outer conductor is electrically connected to the shielding shell, and when the coaxial connector and the mating connector are offset in an up and lower direction the floating terminal module uses the first connecting portion as a fulcrum to deflect radially relative to the fixed terminal module.

12. The coaxial connector assembly as claimed in claim 11, wherein the first outer conductor has a third connecting portion extending downwardly, the second inner conductor has a second connecting portion and a soldering tail, the second outer conductor has a fourth connecting portion and a soldering portion opposite the fourth connecting portion, first connecting portion elastically abuts the second connecting portion downward, and the third connecting portion is floatingly connected to the fourth connecting portion.

13. The coaxial connector assembly as claimed in claim 12, wherein a lower end of the shielding shell has a mouth portion for receiving the first coaxial connector, and the mouth portion is arranged in a trumpet shape and connecting to the first outer conductor.

14. The coaxial connector assembly as claimed in claim 12, wherein the first inner conductor comprises a hollow cylindrical portion and a plurality of mating portions upwardly extending from the cylindrical portion, the first connecting portion is arranged in an S shape and has a first bending portion extending inwards from the cylindrical portion and bending downwardly and a second bending portion extending outwardly from the first bending portion and bending downwardly, the second connecting portion is plate-shaped, and the second bending portion elastically contacts the second connecting portion and deflects radially relative to the second connecting portion.

15. The coaxial connector assembly as claimed in claim 14, wherein the first connecting portion is able to drive the floating terminal module to float in an upper and lower direction relative to the fixed terminal module by elastic bending.

16. The coaxial connector assembly as claimed in claim 14, wherein the third connection portion has a convex ring protruding outwards, the fourth connecting portion has a concave ring recessed inward, and the concave ring clasps the convex ring above for limiting the floating of the third connecting portion and preventing the third connecting portion from falling off the second outer conductor.

17. A coaxial connector comprising:
a floating terminal module comprising a first insulating housing, a first inner conductor received in the first insulating housing, and a first outer conductor surrounding outside of the first insulating housing; and
a fixed terminal module comprising a second insulating housing, a second inner conductor fixed on the second insulating housing, and a second outer conductor surrounding outside of the second insulating housing;
wherein the first inner conductor elastically abuts the second inner conductor downward, the second outer conductor is assembled on the coaxial outside of the first outer conductor, a lower end of the first outer conductor is floatingly connected to an upper end of the second outer conductor, and the floating terminal module uses the first inner conductor as a fulcrum to deflect radially relative to the fixed terminal module.

18. The coaxial connector as claimed in claim 17, wherein the first inner conductor has a mating portion extending upwardly and a first connecting portion extending downwardly, the first outer conductor has a third connecting portion extending downwardly, the second inner conductor has a second connecting portion and a soldering tail, the second outer conductor has a fourth connecting portion and a soldering portion opposite the fourth connecting portion, the first connecting portion elastically abuts the second connecting portion downward, and the third connecting portion is floatingly connected to the fourth connecting portion.

19. The coaxial connector as claimed in claim 18, wherein the first inner conductor comprises a hollow cylindrical portion and a plurality of mating portions upwardly extending from the cylindrical portion, the first connecting portion is arranged in an S shape and has a first bending portion extending inwards from the cylindrical portion and bending downwardly and a second bending portion extending outwardly from the first bending portion and bending downwardly, the second connecting portion is plate-shaped, and the second bending portion elastically contacts the second connecting portion and deflects radially relative to the second connecting portion.

20. The coaxial connector as claimed in claim 19, wherein the first connecting portion is able to drive the floating terminal module to float in an upper and lower direction relative to the fixed terminal module by elastic bending.
